(19) United States
(12) Patent Application Publication
(10) Pub. No.: US 2009/0119124 A1
(43) Pub. Date: May 7, 2009

(54) SYSTEM AND METHOD FOR ENHANCED CLINICAL WORKFLOW

(75) Inventor: Guruprasad Nagaraja Kambaloor, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/934,171

(22) Filed: Nov. 2, 2007

(51) Int. Cl. G06Q 50/00

(52) U.S. Cl. 705/2

(57) ABSTRACT

A method for clinical workflow is presented. The method includes selecting a predefined template, where the predefined template includes one or more parameters associated with a patient. Further, the method includes determining a list of matching devices, where the matching devices are configured to provide the one or more parameters associated with the patient. The method also includes aiding the collection of available matching devices, where the available matching devices include matching devices from the list of matching devices that are not associated with any patient. Systems and computer-readable medium that afford functionality of the type defined by this method is also contemplated in conjunction with the present technique.

### BACKGROUND

The invention relates generally to clinical workflow, and more particularly to methods and apparatus for enhanced patient monitoring and trending workflow.

In a caregiving facility, such as a hospital, caregivers, such as clinicians, patients, medical equipment and consumables interact and move in different ways with different people and places, changing the context of care based on the caregiver, procedure, and urgency, to name a few. Additionally, a patient in the caregiving facility may be operatively coupled to one or more monitoring devices, where the monitoring devices are configured to monitor vital parameters associated with the patient. The monitoring devices may include a pulse oximeter, an electrocardiogram monitor, a blood pressure monitor, for example, where each monitoring device is configured to monitor one or more vital parameters associated with the patient. Also, in a typical caregiving facility, and more particularly, in a critical care setting such as an intensive care unit (ICU) or an emergency room (ER), for instance, the monitoring devices may include one or more portable monitoring devices. However, use of portable monitoring devices may inadvertently result in diminished workflow, as these portable monitoring devices need to be tracked down due to their mobile nature. For example, if monitoring the patient calls for tracking the blood oxygen level of the patient via a portable pulse oximeter, then the clinician needs to track down a current location of the portable pulse oximeter. The clinician may not remember a current location of the portable device, or may not realize that the portable device is not available since the portable device is now being used to monitor another patient. Unfortunately, this results in loss of productivity for the clinicians and consequently affects patient care.

Further, several techniques have been developed to aid the clinician in tracking down the portable medical devices, such as portable pulse oximeters or other monitoring devices. Unfortunately, these techniques generally require the clinician to manually initiate a search for the desired monitoring devices. In other words, the clinician is required to manually determine a list of desired monitoring devices and physically input the list of desired monitoring devices, thereby entailing manual intervention. Additionally, the presently available techniques allow more than one clinician to simultaneously search for the desired monitoring devices, which may disadvantageously lead to device contention. Also, the presently available techniques fail to allow the clinician to concurrently search for more than one device, thereby requiring the clinician to perform a plurality of searches, consequently resulting in inefficiency in clinician productivity and hence may adversely affect patient care. In some situations, the clinician may have to follow a tortuous path to collect all of the desired monitoring devices, which takes time and energy away from caring for the patient.

Moreover, in the caregiving facility, once one or more devices are attached and associated with a given patient, patient device data is viewed, validated and committed to an electronic health record using patient charting systems. There exist manual and automatic methods for associating one or more devices with a given patient. In the traditional manual method, the clinician manually maps or associates a device to a patient. However, this manual association results in loss of clinician productivity. In addition, due to the critical nature of the caregiving facility, such as in the ICU, the ER or the operation theater (OT), there is invariably a time gap between when the device is physically connected to the patient and when the clinician updates the system to include this new patient-device association. This time gap may be circumvented via use of automatic mapping techniques. Currently available automatic mapping techniques employ spatial or locality commonness to facilitate the patient-device association. However, while allowing the automatic mapping of static devices with the patient, the presently available techniques fail to facilitate the automatic mapping of portable devices with the patient.

There is therefore a need for a system for the automatic tracking and subsequent gathering of one or more desired monitoring devices. In particular, there is a significant need for a design that advantageously aids the clinician in automatically deducing a list of desired monitoring devices, obtaining location information associated with the desired monitoring devices, and alerting the clinician to locations of available monitoring devices, thereby substantially enhancing the clinical workflow and productivity of the clinicians. There is also a need for a system for providing route or path information to the clinician to help the clinician efficiently collect the desired monitoring device(s). In addition, there is a need for automatically associating one or more devices with a patient, thereby enhancing patient care.

### BRIEF DESCRIPTION

In accordance with aspects of the present technique, a method for clinical workflow is presented. The method includes selecting a predefined template, where the predefined template includes one or more parameters associated with a patient. Further, the method includes determining a list of matching devices, where the matching devices are configured to provide the one or more parameters associated with the patient. The method also includes aiding the collection of available matching devices, where the available matching devices include matching devices from the list of matching devices that are not associated with any patient. Computer-readable medium that afford functionality of the type defined by this method is also contemplated in conjunction with the present technique.

In accordance with yet another aspect of the present technique, a method for clinical workflow is presented. The method includes selecting a predefined template, where the predefined template includes one or more parameters associated with a patient. In addition, the method includes determining a list of matching devices, where the matching devices are configured to provide the one or more parameters associated with the patient. The method also includes aiding the collection of available matching devices, where the available matching devices include matching devices from the list of matching devices that are not associated with any patient. Furthermore, the method includes attaching the devices to the patient. Moreover, the method includes initiating monitoring of the one or more parameters via the attached devices.

In accordance with further aspects of the present technique, a location sensing system is presented. The location sensing system includes a location sensing platform comprising a location sensor processing module, where the location sensor processing module is configured to obtain location information associated with one or more devices, a patient, or both, where each of the one or more devices, the patient, or both, are operatively coupled to a corresponding location tracking device. Additionally, the location sensing system includes a location proximity detector configured to compute a distance between the patient and the one or more devices.

In accordance with further aspects of the present technique, a system for clinical workflow is presented. The system includes an acquisition subsystem configured to acquire patient data. In addition, the system includes a location sensing platform configured to obtain location information associated with one or more devices, one or more patients, or both; where each of the one or more devices, the one or more patients, or both, are operatively coupled to a corresponding location tracking device. Further, the system includes a location proximity detector in operative association with the location sensing platform and configured to compute a distance between each patient and the one or more devices. The system also includes a processing subsystem in operative association with the acquisition subsystem and configured to select a predefined template, where the predefined template includes one or more parameters associated with a patient, determine a list of matching devices, where the matching devices are configured to provide the one or more parameters associated with the patient, and aid the collection of available matching devices, where the available matching devices include matching devices from the list of matching devices that are not associated with any patient.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary clinical system, in accordance with aspects of the present technique;

FIG. 2 is a block diagram of an exemplary location sensing system in conjunction with the clinical system of FIG. 1, in accordance with aspects of the present technique;

FIGS. 3A-3B are flow charts illustrating an exemplary process of enhanced clinical workflow, in accordance with aspects of the present technique;

FIGS. 4A-4B are flow charts illustrating an exemplary process of determining a list of available matching devices, in accordance with aspects of the present technique;

FIGS. 5A-5B are flow charts illustrating an exemplary process of collecting available matching devices, in accordance with aspects of the present technique;

FIGS. 6A-6B are flow charts illustrating an exemplary process of automatically associating devices with a patient, in accordance with aspects of the present technique;

FIG. 7 is a front view of a user interface area of the exemplary patient monitoring system of FIG. 1, in accordance with aspects of the present technique;

FIG. 8 is a diagrammatic illustration of a clinical flow sheet template, in accordance with aspects of the present technique;

FIG. 9 is a diagrammatical illustration of a portion of the exemplary patient monitoring system of FIG. 1, in accordance with aspects of the present technique; and

FIG. 10 is a diagrammatic illustration of paths generated by the exemplary patient monitoring system of FIG. 1, in accordance with aspects of the present technique.

### DETAILED DESCRIPTION

As will be described in detail hereinafter, a method for enhanced clinical workflow and a system for enhanced clinical workflow are presented. Employing the methods and systems described hereinafter, procedural workflow may be dramatically simplified by enhancing the speed of procedural time taken to provide care to the patient and the productivity of the clinician may be enhanced

Although the exemplary embodiments illustrated hereinafter are described in the context of a medical system, it will be appreciated that use of the clinical system in industrial applications are also contemplated in conjunction with the present technique. For example, a system in accordance with embodiments of the present technique may be used to enhance the workflow of a mechanic working on a task requiring the use of one or more tools, or the workflow of an electronic technician working on troubleshooting an electronic system using a number of instruments, or the workflow of a technician setting up an automatic assembly line in a factory.

Once a patient is admitted to a caregiving facility, such as a hospital, it may be desirable to monitor one or more vital parameters associated with the patient. Medical devices such as monitoring devices may be employed to monitor vital parameters associated with the patient. Also, these monitoring devices may include portable monitoring devices. Traditionally, a clinical workflow entails a clinician, such as a nurse, manually determining a list of monitoring devices required to monitor the patient parameters. Subsequently, the clinician tracks down desired monitoring devices, resulting in diminished productivity of the clinician and an inefficient workflow, and thereby unfortunately resulting in a delay in providing care to the patient. Accordingly, a system 10 for enhanced clinical workflow is presented, in accordance with aspects of the present technique. It may be noted that although embodiments of the present technique described hereinafter are described in terms of monitoring devices, use of the present technique with portable diagnostic and/or imaging devices, such as, but not limited to a portable X-ray imaging system, a portable electrocardiogram (ECG/EKG) system, or a portable ultrasound imaging system, is also contemplated in conjunction with aspects of the present technique.

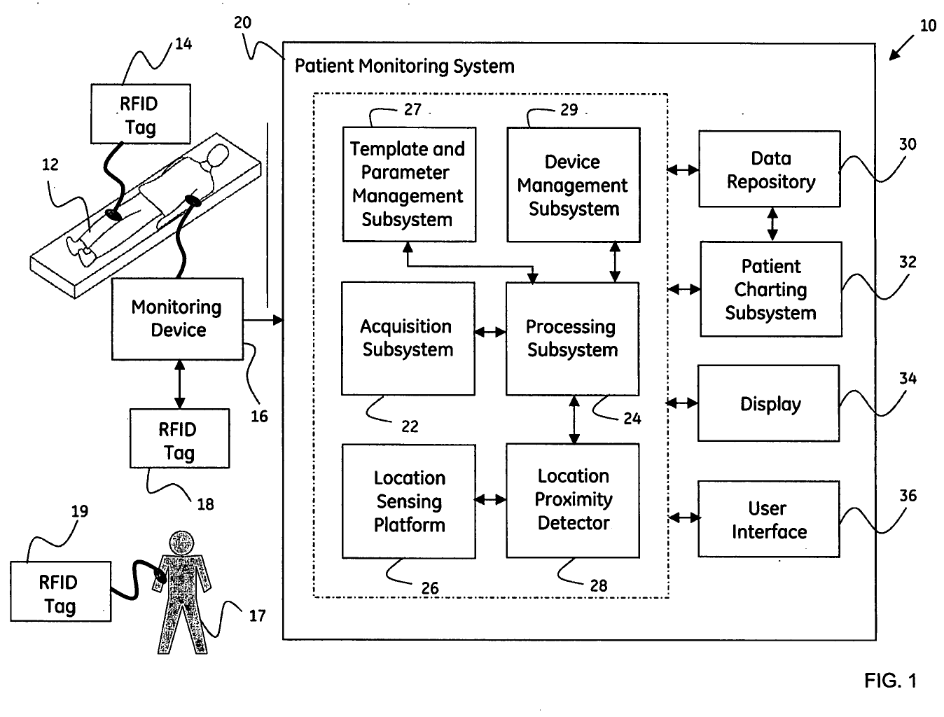

FIG. 1 is a block diagram of an exemplary system 10 for use in monitoring a patient in a caregiving facility, in accordance with aspects of the present technique. It may be noted that the caregiving facility may include a hospital, a clinic or a long-term care facility, for example. More particularly, the caregiving facility may include an intensive care unit (ICU), a critical care unit (CCU), a neonatal intensive care unit (NICU), an operating room (OR), or an emergency room (ER), to name a few.

The system 10 may be configured to monitor data associated with a patient 12, where the patient data may include vital patient parameters. For example, the patient parameters may include a temperature, systolic and diastolic blood pressure, a pulse rate, or an oxygen saturation of hemoglobin in arterial blood (a blood oxygen level) (SpO₂), to name a few. The patient data may be obtained via one or more medical devices that are operatively coupled to the patient 12. It may be noted that the one or more medical devices may be configured to monitor different patient vital parameters associated with the patient. For example, the blood pressure of a patient 12 may be measured via use of a blood pressure monitor that is operatively coupled to the patient 12, while a thermometer may be used to measure the temperature of the patient 12. Alternatively, a single medical device may be used to measure one or more parameters. By way of example, a pulse oximeter may be used to measure both SpO₂ and the pulse rate of the patient 12. Another example may include a multi-parameter patient monitor which may be configured to simultaneously monitor an electrocardiogram, SpO₂, a temperature, and a non-invasive blood pressure (NIBP). In accordance with aspects of the present technique, it may be desirable to use such multi-parameter patient monitors to enhance patient comfort and optimize use of the monitoring devices. More particularly, it may be desirable to couple a single multi-parameter patient monitor to monitor five (5) patient parameters, for example, as opposed to coupling five different monitoring devices to the patient 12, where the five monitoring devices are each configured to monitor a single patient parameter, thereby enhancing patient comfort.

As described hereinabove, the system 10 may be configured to facilitate monitoring the vital parameters of the patient 12 via use of one or more monitoring devices. Hence, it may be desirable to automatically determine a list of patient parameters that need to be monitored. It may also be desirable to automatically deduce a list of monitoring devices configured to monitor the list of desired patient parameters. In accordance with exemplary aspects of the present technique, the system 10 may be configured to automatically deduce the list of desired patient parameters. Additionally, the system 10 may also be configured to automatically determine the list of desired monitoring devices, in accordance with further aspects of the present technique.

In the example illustrated in FIG. 1, the patient 12 is shown as being operatively coupled to one medical device, such as a monitoring device 16. However, as will be appreciated, more than one monitoring device may be operatively associated with the patient 12. Additionally, the monitoring device 16 may include a stationary monitoring device that is positioned at a predetermined location. Alternatively, the monitoring device 16 may include a portable device.

The system 10 may be configured to automatically track the location of one or more patients in the hospital, such as the patient 12. Accordingly, the system 10 may include a first location sensing device 14, where the first location sensing device 14 may be configured to provide location information associated with the patient 12. As used herein, the term location information is used to represent positional coordinates of the patient 12 with reference to a patient monitoring system 20, for example. In one embodiment, the first location sensing device 14 may include a radio frequency identification (RFID) device or tag. Furthermore, the first location sensing device 14 may be in operative association with the patient 12. Also, in one embodiment, the first location sensing device 14 may be disposed adjacent to the patient 12. Alternatively, the first location sensing device 14 may be operatively coupled to a patient support that the patient 12 is currently disposed on. The patient support may include a bed or a room, for instance.

Furthermore, the system 10 may also be configured to automatically track the locations of the desired monitoring devices to aid the clinician in gathering the desired monitoring devices, in accordance with exemplary aspects of the present technique. As noted hereinabove, the monitoring devices may include portable monitoring devices. Hence, in a hospital setting, especially in a critical care setting like the ICU, the CCU, the NICU, the OR or the ER, it may be desirable to obtain information associated with a current location of the monitoring devices. More particularly, it may be desirable to obtain location information associated with the portable monitoring devices. In other words, location information associated with the monitoring devices, especially the portable monitoring devices, advantageously aids the clinician in tracking a current location of the portable monitoring devices. Accordingly, the system 10 may also include a second location sensing device 18, where the second location sensing device 18 may be configured to provide location information associated with the monitoring device 16. As used herein, the term location information is used to represent positional coordinates of the monitoring device 16 with reference to the patient monitoring system 20, for example. Here again, the second location sensing device 18 may include a RFID device or tag. In addition, the second location sensing device 18 may be operatively coupled with the monitoring device 16. The second location sensing device 18 may be disposed adjacent to the monitoring device 16. Alternatively, the second location sensing device 18 may be embedded within the monitoring device 16, in certain embodiments.

Moreover, the system 10 may also be configured to automatically track the location of one or more clinicians in the hospital, such as a clinician 17. Accordingly, the system 10 may include a third location sensing device 19, where the third location sensing device 19 may be configured to provide location information associated with the clinician 17. As used herein, the term location information is used to represent positional coordinates of the clinician 17 with reference to the patient monitoring system 20, for example. In one embodiment, the third location sensing device 19 may include a radio frequency identification (RFID) device or tag. Furthermore, the third location sensing device 19 may be in operative association with the clinician 17. Also, in one embodiment, the third location sensing device 19 may be disposed adjacent to the clinician 17. Alternatively, the third location sensing device 19 may be operatively coupled to a personal digital assistant (PDA) that the clinician 17 is carrying.

Moreover, the system 10 may also include a patient monitoring system 20. In one embodiment, the patient monitoring system 20 may be configured to acquire patient data associated with the patient 12 via the one or more monitoring devices, such as the monitoring device 16 attached to the patient 12. Also, the patient monitoring system 20 may be configured to process the acquired patient data to aid the clinician in monitoring the patient 12. For example, the patient monitoring system 20 may be configured to display a visual representation of the patient data on a display. In the present example, the patient monitoring system 20 is shown as being operatively coupled with the monitoring device 16. Accordingly, the patient monitoring system 20 may be configured to obtain patient data associated with the patient 12 via the monitoring device 16.

Although the present example illustrates the monitoring device 16 as being coupled to the monitoring system 20 via a cable, it will be understood that the monitoring device 16 may be coupled with the patient monitoring system 20 via other means, such as wireless means, for example. Also, in certain other embodiments, patient data may be acquired by the patient monitoring system 20 via one or more sensors (not shown) that may be disposed on the patient 12. By way of example, the sensors may include physiological sensors (not shown), such as electrocardiogram (ECG) sensors and/or positional sensors, such as electromagnetic field sensors or inertial sensors. These sensors may be operationally coupled to a data acquisition device, such as the patient monitoring system 20, via leads (not shown), for example.

Furthermore, in a presently contemplated configuration, the patient monitoring system 20 may include an acquisition subsystem 22 and a processing subsystem 24. The acquisition subsystem 22 may be configured to aid in the acquisition of information associated with the patient 12. For example, the acquisition subsystem 22 may be configured to obtain information about the patient 12 that may be input by the clinician 17, where the patient information may include a list of patient parameters that need to be monitored. Additionally, the acquisition subsystem 22 may also be configured to acquire patient data. In other words, the acquisition subsystem 22 may be configured to obtain the patient data via the monitoring device 16, for example.

In a presently contemplated configuration, the acquisition subsystem 22 is shown as being in operative association with the processing subsystem 24. Further, the acquisition subsystem 22 may be configured to communicate the patient information to the processing subsystem 24. The processing subsystem 24 may also be configured to process the patient information to automatically deduce a list of desired patient parameters. More particularly, once the patient 12 is admitted and a clinician selects a clinical flow sheet corresponding to the patient 12, the processing subsystem 24 may be configured to automatically deduce the list of desired patient parameters from the selected patient flow sheet. In a presently contemplated configuration, a template and parameter management subsystem 27 may be employed to automatically deduce the list of desired patient parameters from the selected flow sheet.

Furthermore, once the list of desired parameters is deduced from the selected flow sheet, the processing subsystem 24 may also be configured to automatically determine the list of desired monitoring devices, where the desired monitoring devices may be configured to monitor the desired patient parameters. In a presently contemplated configuration, the processing subsystem 24 may be configured to automatically determine the list of desired monitoring devices via use of a device management subsystem 29. It may be noted that it may be desirable to optimize the number of desired monitoring systems. In other words, it may be desirable use a multi-parameter patient monitor. However, it may be noted that a multi-parameter patient monitor may be selected only if the list of desired patient parameters includes two or more of the parameters that the multi-parameter patient monitor is configured to measure. In another embodiment, device management subsystem 29 may be configured to automatically determine a combination of single-parameter and multi-parameter patient monitors that together include all of the desired patient parameters.

In accordance with exemplary aspects of the present technique, the processing subsystem 24 may also be configured to track the current locations of the desired monitoring devices. Once the current location of each of the desired monitoring devices is obtained, the processing subsystem 24 may also be configured to aid the clinician in gathering the desired monitoring devices. Moreover, subsequent to gathering the desired monitoring devices and operatively coupling the desired monitoring devices to the patient 12, the patient data acquired from the patient 12 may be processed by the processing subsystem 24. For example, the processing subsystem 24 may be configured to process the acquired patient data into a format suitable for display.

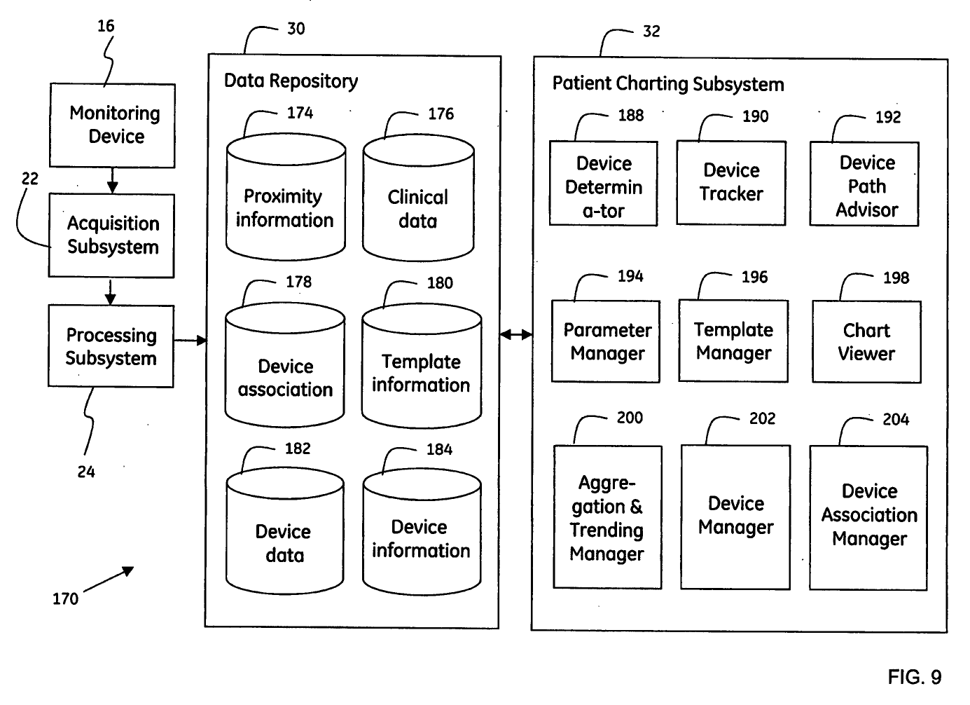

Additionally, the patient data acquired and/or processed by the patient monitoring system 20 may be employed to aid the clinician in monitoring vital patient parameters. The patient data may also be used to aid the clinician in identifying disease states, assessing need for treatment, determining suitable treatment options, and/or monitoring the effect of treatment on the disease states. In certain embodiments, the processing subsystem 24 may be further coupled to a storage system, such as a data repository 30, where the data repository 30 may be configured to receive and/or store the patient data. In one embodiment, the data repository 30 may include an application database, and will be described in greater detail with reference to FIG. 9. The patient monitoring system 20 may also include a patient charting subsystem 32. In certain embodiments, the patient charting subsystem 32 may be configured to aid the clinician in monitoring patient data, and will be described in greater detail with reference to FIG. 9.

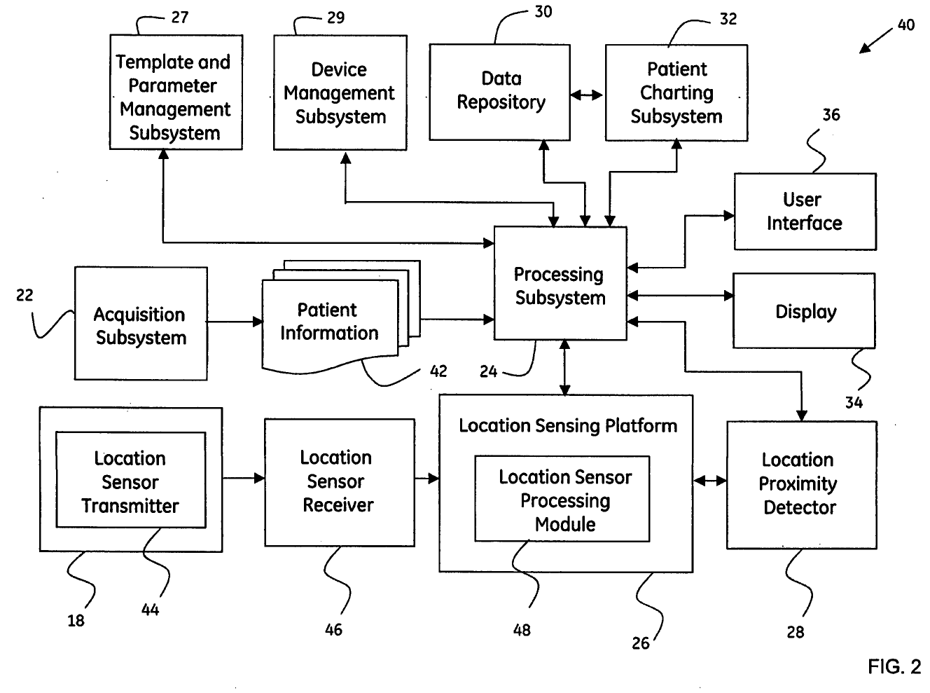

In accordance with exemplary aspects of the present technique, the patient monitoring system 20 may include a location sensing platform 26. The location sensing platform 26 may be configured to aid the clinician in tracking the present locations of the patient 12, the clinician 17, and/or the desired monitoring devices, such as the monitoring device 16. More particularly, the location sensing platform 26 may be configured to obtain location information associated with the patient 12 via the first location sensing device 14. Similarly, the location sensing platform 26 may also be configured to obtain location information associated with one or more monitoring devices existing within a caregiving facility, such as a hospital, for instance. In the present example, the location sensing platform 26 may be configured to obtain location information associated with the monitoring device 16 via the second location sensing device 18. The location sensing platform 26 may also be configured to obtain location information associated with the clinician 17 via the third location sensing device 19. Furthermore, the location sensing platform 26 may also be configured to communicate the location information to the processing subsystem 24 thereby aiding the processing subsystem 24 in determining current locations of the patient 12, the monitoring device 16, the clinician 17, or a combination thereof. The working of the location sensing platform 26 will be described in greater detail with reference to FIGS. 2-10.

In accordance with further aspects of the present technique, the patient monitoring system 20 may also include a location proximity detector 28. The location proximity detector 28 may be configured to store the location information associated with the one or more monitoring devices existing within the caregiving facility, such as a hospital. Further, location information corresponding to patients and/or the clinicians in the hospital may also be stored in the location proximity detector 28. Moreover, the location proximity detector 28 may also include a storage (not shown in FIG. 1) configured to store room-to-room proximity information, location-to-location proximity information, bed-to-bed proximity information; or combinations thereof. It may be noted that the storage may be separate from the location proximity detector 28, in certain embodiments. The storage configured to store the proximity information may include a proximity information database (not shown in FIG. 1). In one embodiment, the proximity information may be stored in terms of relative distance. By way of example, if a first room and a second room are adjacently located, then a relative distance between the first and second rooms may be indicated as one (1). However, if there is a room in between the first room and the second room, then the relative distance between the first and second rooms may be indicated as two (2). This proximity information may be stored in the proximity information database, for example. It may be noted that the proximity information may include relative distances between rooms that are located on the same floor, the same building, across buildings, or combinations thereof. Using the proximity information, a distance to one or more desired monitoring devices may be computed. Alternatively, in accordance with aspects of the present technique, the proximity information may be automatically generated. For example, given a floor plan of the hospital, the processing subsystem 24 may be configured to automatically compute distances between rooms and store the proximity information in the proximity information database.

Additionally, in accordance with exemplary aspects of the present technique, the processing subsystem 24 may also be configured to generate a plurality of paths indicative of current locations of the one or more desired monitoring devices may be generated, where the paths may be configured to aid the clinician 17 in collecting the desired monitoring devices. The working of the location proximity detector will be described in greater detail with reference to FIGS. 2-10.

With returning reference to the processing subsystem 24, in accordance with exemplary aspects of the present technique, the processing subsystem 24 may also be configured to obtain the location information associated with the one or more monitoring devices, one or more patients, and/or one or more clinicians from the location sensing platform 26. Furthermore, the processing subsystem 24 may also be configured to obtain the proximity information from the location proximity detector 28. The processing subsystem 24 may then use the information obtained from the location sensing platform 26 and the location proximity detector 28 to determine a list of available desired devices and provide one or more paths indicative of current locations of the available desired devices, thereby aiding the clinician in gathering the available desired devices. Additionally, the processing subsystem 24 may also be configured to process patient data. For example, the processing subsystem 24 may be configured to store the patient data into a database and generate and communicate alerts if the received patient data received is outside a normal range. The working of the processing subsystem 24 will be described in greater detail with reference to FIGS. 2-10.

Further, as illustrated in FIG. 1, the patient monitoring system 20 may include a display 34 and a user interface 36. However, in certain embodiments, such as in a touch screen, the display 34 and the user interface 36 may overlap. Also, in some embodiments, the display 34 and the user interface 36 may include a common area. In accordance with aspects of the present technique, the display 34 of the patient monitoring system 20 may be configured to display patient data obtained from the one or more monitoring devices, such as the monitoring device 16. In addition, the one or more paths generated by the processing subsystem 24 may also be displayed on the display 34 and will be described in greater detail with reference to FIGS. 2-10.

In addition, the user interface 36 of the patient monitoring system 20 may include a human interface device (not shown in FIG. 1) configured to aid the clinician in selecting a path to collect the available desired monitoring devices, for example. The human interface device may include a mouse-type device, a trackball, a joystick, a stylus, or buttons configured to aid the clinician 17 in selecting one of the one or more displayed paths. However, as will be appreciated, other human interface devices, such as, but not limited to, a touch screen, may also be employed. Furthermore, in accordance with aspects of the present technique, the user interface 36 may be configured to aid the clinician 17 in navigating through the patient data acquired by the patient monitoring system 20. Additionally, the user interface 36 may also be configured to aid in visualizing the acquired patient data and/or the paths generated for display on the display 34 and will be described in greater detail with reference to FIGS. 2-10.

Referring now to FIG. 2, a block diagram 40 of one embodiment of the system 10 of FIG. 1 is depicted. The acquisition subsystem 22 may be configured to obtain patient data 42 from one or more monitoring devices, as previously noted. It may be noted that the patient data 42 may be representative of vital patient parameters, in certain embodiments. Further, the processing subsystem 24 may be configured to process the acquired patient data 42 to aid a clinician in monitoring the patient data. The clinician may monitor the patient data 42 via use of a display, such as the display 34.

As previously noted with reference to FIG. 1, the system 10 may be configured to facilitate acquisition of location information associated with the patient 12 (see FIG. 1), the clinician 17 (see FIG. 1), one or more desired monitoring devices (such as monitoring device 16 (see FIG. 1)), or combinations thereof, computation of distance between the patient 12 and/or the clinician 17 and one or more desired monitoring devices and determination of a plurality of paths to aid the clinician 17 in gathering the desired monitoring devices. Accordingly, the system 40 may include a location sensing device, such as the second location sensing device 18 (see FIG. 1), where the location sensing device 18 may be configured to provide positional coordinates corresponding to a current location of the one or more desired monitoring devices, such as the monitoring device 16. In a present example, the second location sensing device 18 may include a RFID tag, as previously noted. Also, in one embodiment, the second location sensing device 18 may be operatively coupled to monitoring device 16. Further, the second location sensing device 18 may include a location sensor transmitter 44 configured to communicate the location information associated with the monitoring device 16. The location sensor transmitter 44 may be configured to communicate the location information associated with the monitoring device 16 to a location sensor receiver 46. In one embodiment, the position sensor transmitter 44 may be disposed on the second location sensing device 18. However, as will be appreciated, the location sensor transmitter 44 may be disposed at other locations.

It may be noted that the location sensor receiver 46 may also be configured to receive location information associated with the patient 12 and/or the clinician 17 from a location sensor transmitter (not shown in FIG. 2) corresponding to the first location sensing device 14 and the third location sensing device 19. Additionally, location information associated with other monitoring devices may also be communicated to the location sensor receiver 46 via corresponding location sensor transmitters in the respective position sensing devices.

Further, the location sensor receiver 46 may be configured to communicate the location information to the location sensing platform 26. In accordance with exemplary aspects of the present technique, the location sensing platform 26 may be configured to include a location sensor processing module 48. As illustrated in the example of FIG. 2, the location sensor receiver 46 is operatively coupled with the location sensing platform 26, and more particularly with the location sensor processing module 48. In one embodiment, the location sensor receiver 46 may be configured to communicate location information associated with the monitoring device 16 to the location sensor processing module 48. The location sensor processing module 48 may in turn be configured to utilize this location information to compute distances between a current location of the patient 12 and the plurality of desired monitoring devices. In addition, the location sensor processing module 48 may also be configured to compute distances between a current location of the clinician 17 that initiated the search for the desired monitoring devices and the plurality of desired monitoring devices. More particularly, the location sensor processing module 48 may be configured to obtain proximity information from the location proximity detector 28 and use the proximity information to compute the distances between the patient 12 and/or the clinician 17 and the plurality of desired monitoring devices. The processing subsystem 24 may also be configured to provide one or more paths to aid the clinician 17 in gathering the desired devices. In other words, the patient monitoring system 20 and more particularly, the processing subsystem 24, may be configured to present to the clinician 17 the plurality of paths, and also allow the clinician 17 to select an optimal path to gather the desired devices.

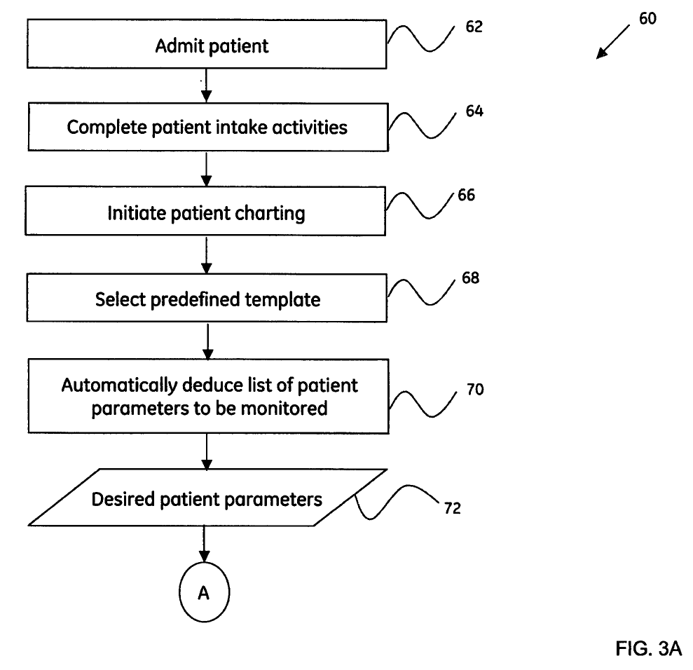

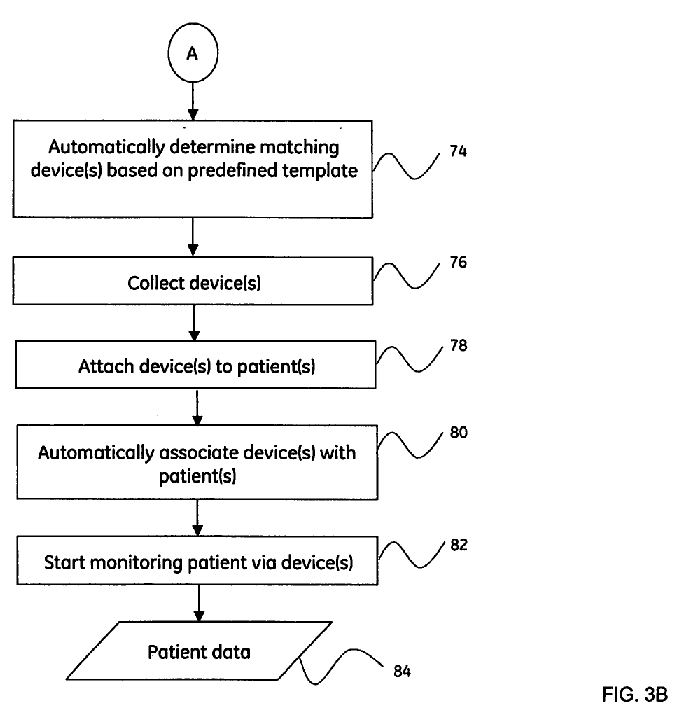

Additionally, the system 40 may also include the user interface 36, as previously noted with reference to FIG. 1. The user interface 36 may be operatively coupled with the processing subsystem 24, where the user interface 36 may be configured to aid the clinician 17 in obtaining a list of desired monitoring devices and selecting one or more paths to gather the desired monitoring devices. Also, as previously described, the system 40 may include the display 34. The display 34 may be in operative association with the processing subsystem 24, and the plurality of paths generated by the processing subsystem 24 may be displayed on the display 34. The patient data 42 being monitored may also be displayed on the display 34. The working of the system 40 will be explained in greater detail with reference to FIGS. 3-10.

Referring now to FIGS. 3A-3B, a flow chart 60 illustrating an exemplary method of enhanced clinical workflow is presented. The method starts at step 62, when a patient, such as the patient 12 (see FIG. 1) is admitted to a caregiving facility, such as a hospital. Also, formalities, such as registration and patient in-take may be performed as indicated by step 64. For example, at step 64, a height and weight of the patient may be recorded in addition to obtaining a patient history.

Once the patient is admitted to the caregiving facility, a clinician, such as a nurse, may initiate charting of the admitted patient, as depicted by step 66. Further, the patient charting mechanism may include one or more clinical flow sheets or vital data monitoring and trending applications. These clinical flow sheets may be configured to provide a method for recording and/or displaying pertinent clinical information associated with the patient. In other words, these forms may be used in a clinical chart to help create a record of vital data monitored, significant events of interest and condition-specific information associated with the patient during the stay in the hospital. In addition, the clinical flow sheet may be derived from one or more predefined templates configured to aid in monitoring the patient. Moreover, the predefined templates may be associated with a department in the hospital, a disease condition, or both, for example. Accordingly, the predefined templates may include at least a corresponding list of patient vital parameters to be monitored based on the department and/or disease condition. As will be appreciated, the predefined template is a tool that is configured to provide a standard layout and look and feel across the caregiving facility. In addition, the predefined template may be configured to facilitate providing appropriate care to the patient by aiding the clinician in ensuring that all patient parameters of interest are being appropriately monitored.

Subsequently, at step 68, a predefined template from a list of available templates may be selected. For example, the clinician may be configured to select the predefined template from a list of available templates based on the department that the patient is admitted to and/or the disease condition of the patient. It may also be noted that system 10 (see FIG. 1) may be configured to provide a default template based on diagnosis or the department that the patient is admitted to. The clinician may then either choose to use the default template or may override the default template with selection of another predefined template. Furthermore, the clinician may also be allowed to select a predefined template based on a list of patient parameters that need to be monitored. Additionally, the clinician may also be permitted to modify the patient parameters listed in the selected predefined template. For example, the clinician may add one or more patient parameters to the selected predefined template or delete one or more patient parameters from the selected predefined template.

In accordance with exemplary aspects of the present technique, once the predefined template is selected, a list of patient parameters that needs to be monitored may be automatically deduced from the selected predefined template, as depicted by step 70. As will be appreciated, the list of patient parameters may include “manual” parameters, such as weight of the patient, that need to be manually monitored by the clinician. The list of patient parameters may also include “automatic” parameters, such as a pulse rate of the patient, that may be automatically monitored by a monitoring device. In addition, the list of patient parameters may also include “derived” parameters, such as fluid retention, that may be computed using the other monitored patient parameters. According to aspects of the present technique, at step 70, once the predefined template associated with the patient is selected, a list of “automatic” patient parameters to be monitored may be automatically determined from the selected predefined template. These patient parameters may generally be referred to as “desired” patient parameters. Reference numeral 72 may be representative of this list of desired patient parameters.

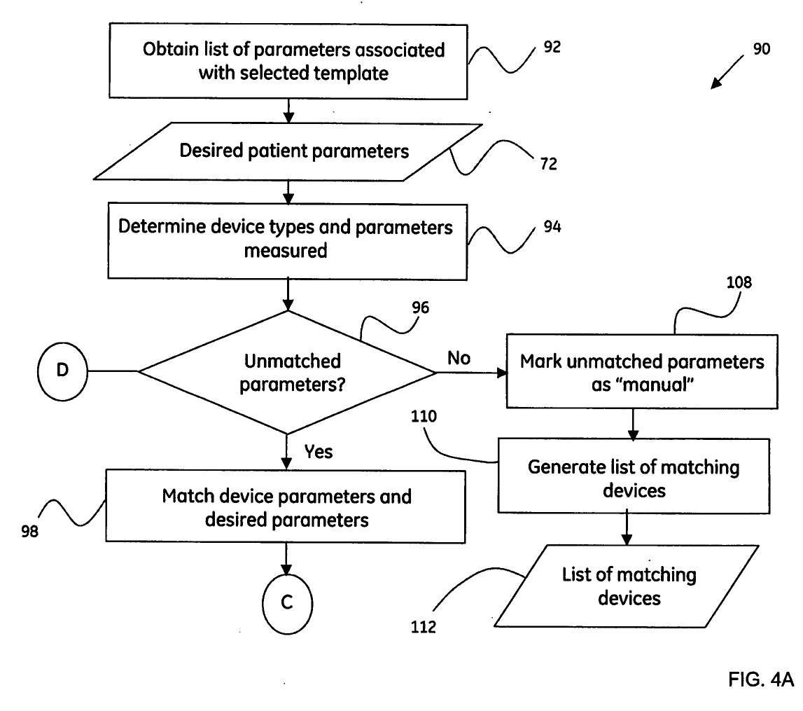

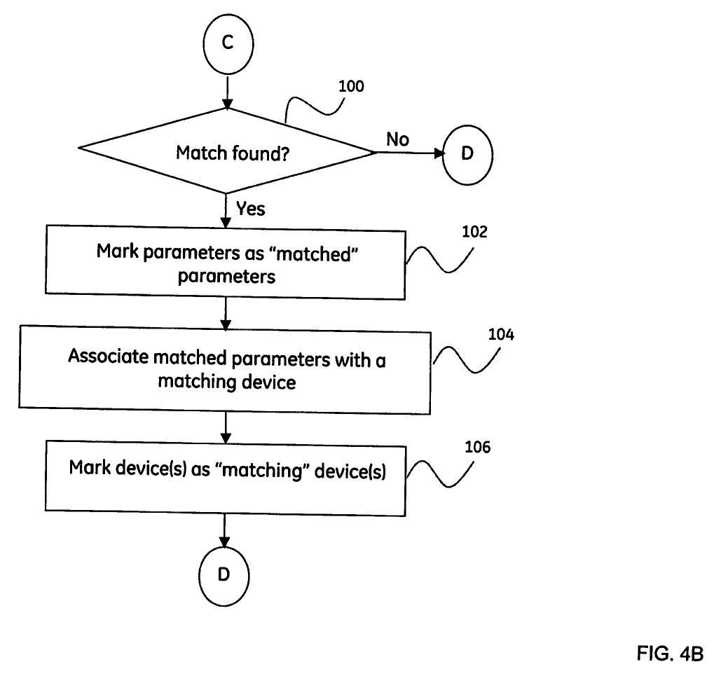

With continuing reference to FIG. 3, once the list of desired patient parameters 72 to be monitored is automatically deduced from the selected predefined template, it may be desirable to determine a list of devices that are configured to monitor these desired patient parameters 72. The devices configured to monitor the desired patient parameters 72 may generally be referred to as matching devices. Accordingly, at step 74, a list of matching devices based on the selected predefined template may be determined. In other words, the list of matching devices may be determined based on the list of desired patient parameters 72. Step 74 may be better understood with reference to FIGS. 4A-4B.

Turning now to FIGS. 4A-4B, a flowchart 90 illustrating an exemplary method of determining the list of matching devices based on the selected predefined template is presented. The method starts at step 92, where a list of patient parameters associated with the selected predefined template may be obtained. For example, the list of patient parameters may include the list of desired patient parameters 72 (see FIG. 3). In one embodiment, the list of desired patient parameters associated with the selected predefined template may include a temperature, systolic and diastolic blood pressure, a blood oxygen level, and a pulse rate, for example. Consequent to step 92, the list of desired patient parameters 72 associated with the selected predefined template may be obtained. It may be noted that the terms patient parameters, desired patient parameters and vital data may be used interchangeably.

Once the list of desired patient parameters 72 to be monitored is obtained, it may be desirable to determine a list of devices, such as monitoring devices that are configured to monitor these desired patient parameters 72. In accordance with exemplary aspects of the present technique, a method of automatically deducing a list of desired devices or device types is presented, where the list of desired device types may include devices that are configured to monitor the list of desired patient parameters 72.

Accordingly, at step 94, a list of all device types existing within a caregiving facility, such as a hospital, may be obtained. The device types may include a blood pressure monitor, a fluid pump, or a pulse oximeter, to name a few. In addition, at step 94, parameters provided by each of the device types existing within the caregiving facility may be recorded. For example, the pulse oximeter is a monitoring device that is configured to indirectly measure an amount of oxygen in the patient's blood, while the blood pressure monitor is configured to measure the systolic and diastolic blood pressure of the patient. Consequent to step 94, a list of all the device types existing in the caregiving facility and the corresponding parameters that may be measured by the device types may be obtained.

As noted hereinabove, at step 92, the list of desired patient parameters 72 is determined. Hence, there exists a need to determine one or more device types that are configured to monitor the desired patient parameters 72 from the list of all the device types. The one or more devices types that are configured to monitor the desired patient parameters 72 may be referred to as matching devices, as previously noted. In accordance with aspects of the present technique, a method for automatically determining a list of matching devices is provided.

Accordingly, a check may be carried out at step 96 to verify if there exist device types that are configured to monitor the desired parameters 72. More particularly, it may be desirable to verify if there are any desired patient parameters 72 that have not been associated with at least one matching device. In other words, a check may be carried out to determine if there are matching device types that are configured to provide and/or monitor any unmatched desired patient parameters 72. Further, at step 96, if it is verified that there exist device types configured to monitor the desired patient parameters and/or unmatched patient parameters, the unmatched desired patient parameters may be matched with one or more device types, at step 98. In other words, at step 98, a matching procedure may be performed to match an unmatched desired parameter with a corresponding matching device type. For example, if the unmatched desired patient parameter includes a blood oxygen level, then the list of matching device types may be scanned to find a device configured to monitor a blood oxygen level.

Subsequently, at step 100, a check may be carried out to verify if a matching device type is found for a given unmatched desired patient parameter. At step 100, if a match is found, then the unmatched desired parameter may be marked as a “matched” desired parameter, as indicated by step 102. Once an unmatched desired parameter is marked as a matched desired parameter, that parameter may be associated with the matching device, at step 104. Also, at step 106, the matching device may be marked as a “desired” matching device.

Referring again to decision block 100, if a matching device is not found, then control may be returned to step 96, where a check may be carried out to verify if there exist any unmatched desired parameters and/or devices. Steps 96-106 may be repeated for any unmatched desired parameters. Moreover, with returning reference to decision block 96, if there exist any unmatched desired parameters, while there are no matching device types available, then those unmatched desired parameters may be marked as needing manual intervention to be matched, as indicated by step 108. Subsequently, at step 110, a list of desired matching device types 112 may be generated. This list of desired matching device types 112 may include the devices marked at step 106, for instance. Steps 96-110 may be repeated for all the desired patient parameters in the list. Consequent to the processing of steps 92-110, the list of desired matching devices 112 may be obtained.

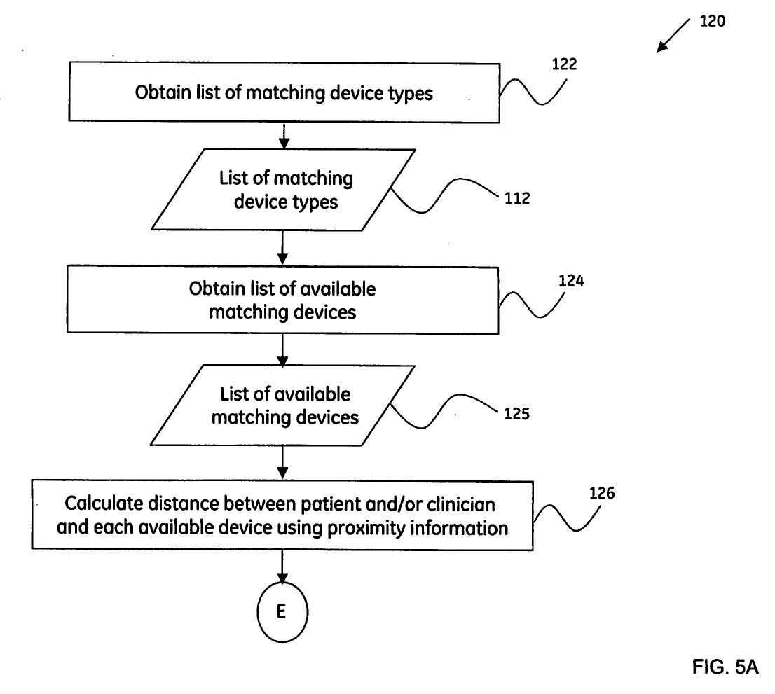

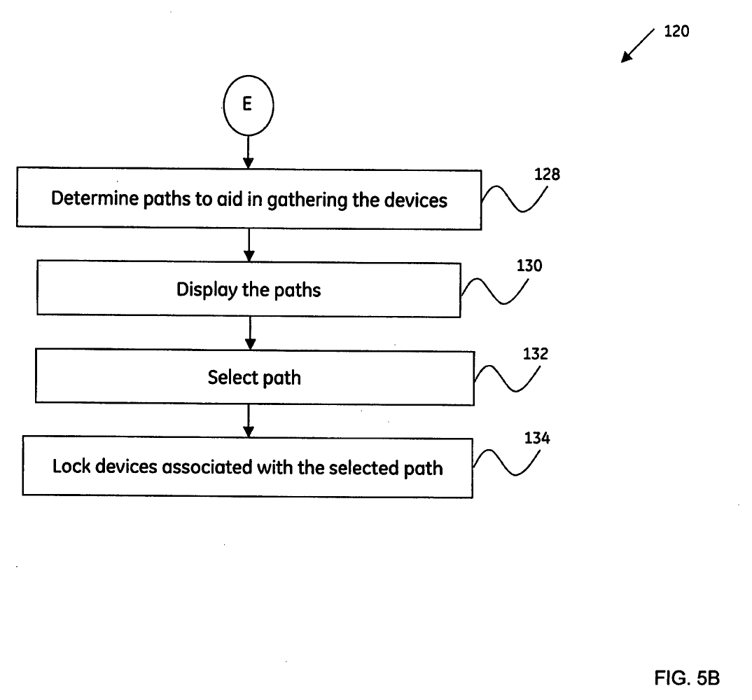

With returning reference to FIG. 3, at step 76, once the list of matching devices 112 (see FIG. 4) is generated, it may be desirable to collect the matching devices 112 in order to monitor the patient. Accordingly, an exemplary method configured to aid a clinician in collecting the matching devices is presented. This method of collecting the matching devices 112 at step 76 may be better understood with reference to FIGS. 5A-5B. FIGS. 5A-5B illustrates a flow chart 120 of exemplary logic for collecting the desired matching devices. The method starts at step 122, where a list of desired matching devices, such as the list of matching devices 112 may be obtained.

Subsequently, in accordance with aspects of the present technique, at step 124, the list of desired matching devices 112 may be processed to determine a current status of each of the desired matching devices 112. More particularly, a search for desired matching devices 112 that are currently not in use or have been locked for use by another clinician may be performed. In other words, available or unassociated devices in the list of desired matching devices 112 may be identified at step 124. As used herein, the terms available device and unassociated device may be used to refer to desired matching devices that are currently not associated with any patient. These unassociated matching devices may generally be represented by reference numeral 125. It may be noted that the terms unassociated matching devices and available matching devices may be used interchangeably.

Following the identification of unassociated matching devices 125, a distance between the location of the patient and each of the unassociated matching devices 125 may be computed. A distance between the location of the clinician and each of the unassociated matching devices 125 may also be computed. More particularly, in accordance with aspects of the present technique, the distance between the location of the patient and/or the clinician and each of the unassociated matching devices 125 may be computed based on proximity information. It may be noted that the proximity information may be previously stored in a proximity information database, as previously noted with reference to FIG. 2. The proximity information may include room-to-room proximity information and/or bed-to-bed proximity information, as previously noted. The location proximity detector 28 (see FIG. 2) may be configured to store the location information associated with the one or more monitoring devices in the hospital. Further, location information corresponding to patients in the hospital may also be stored.

As will be appreciated, the current location of each of the unassociated matching devices 125 may be tracked via corresponding RFID tags attached to the devices 125. Similarly, current locations of the patient and/or the clinician may also be obtained via RFID tags corresponding to the patient and the clinician. Using the previously stored proximity information, and the current locations of the unassociated matching devices 125, distance between the location of the patient and/or the clinician and the unassociated desired matching devices 125 may be computed, as depicted by step 126.

Furthermore, at step 128, in accordance with exemplary aspects of the present technique, one or more paths to aid the clinician in collecting the unassociated matching devices 125 may be generated. These paths may be configured aid the clinician, such as the nurse, in collecting the unassociated matching devices 125, thereby enhancing the clinical workflow. More particularly, these paths may be generated using the proximity information and the current locations of the patient and/or the clinician. Also, at step 130, the generated paths may then be processed for display on a display, such as the display 34 (see FIG. 1). In certain embodiments, the display of the paths on the display 34 may be organized such that the paths are displayed in an order of increasing distance. For example, an optimal path may be displayed at the top of the plurality of paths. The optimal path may include a path of shortest distance between the patient and/or the clinician and the unassociated matching devices. In accordance with further aspects of the present technique, each path may include a proximity identifier, where the proximity identifier may be configured to indicate if the path corresponds to the distance between the patient and the devices 125 or the distance between the clinician and the devices 125. It may be noted that a number of paths to be displayed may include a predetermined value. However, the number of paths to be displayed may be modified by the clinician.

Once the paths are generated and displayed, the clinician may select a path from the plurality of displayed paths, as indicated by step 132. In certain embodiments, the clinician may select the optimal path. Further, in accordance with aspects of the present technique, once the clinician selects a path, devices associated with that path may be “locked”, as depicted by step 134. More particularly, the devices associated with the selected path may be marked as being unavailable to another clinician. Locking the devices associated with the selected path advantageously prevents any device contention with similar searches that may be run by other clinicians. In other words, the lock on the devices may be configured to prevent other clinicians from trying to acquire and/or lock these devices during the transit of the devices locked by the first clinician to the patient location or during the transit of the first clinician to collect the locked devices. For example, a first clinician C1 and a second clinician C2 may simultaneously initiate a search for a first monitoring device M1 and a second monitoring system M2. In a present example, the nearest location of the monitoring devices M1, M2 may include Room 123. This information may be communicated to both the clinicians C1, C2. Consequently, this search by the two clinicians C1, C2 may result in a device conflict, thereby resulting in diminished productivity as at least one clinician may have to redo the search. However, in accordance with exemplary aspects of the present technique, the system 10 (see FIG. 1) may be configured to mark the devices M1, M2 as being “locked” by the first clinician, for instance, and hence prevents any device conflict between the two clinicians C1, C2. It may be noted that these locks may include a time-bound lock. Accordingly, the lock may be automatically released after a predetermined timeout period, if the device is not collected within the predetermined timeout period. With returning reference to FIG. 3, subsequent to step 76, the clinician may collect the available matching devices associated with the selected path. Subsequently, at step 78, the collected matching devices may be operationally coupled with the patient.

In accordance with further aspects of the present technique, the collected matching devices may be automatically associated with the patient, as depicted by step 80. Use of previously available techniques entailed manually mapping or associating a device to a patient, thereby resulting in loss of productivity for the clinicians. Also, there exist techniques for automatically associating devices with a patient. However, these techniques rely on spatial and/or locality commonness to perform the association. Furthermore, these techniques are suitable for associating static devices with the patient and fail to associate mobile and/or portable devices to the patient.

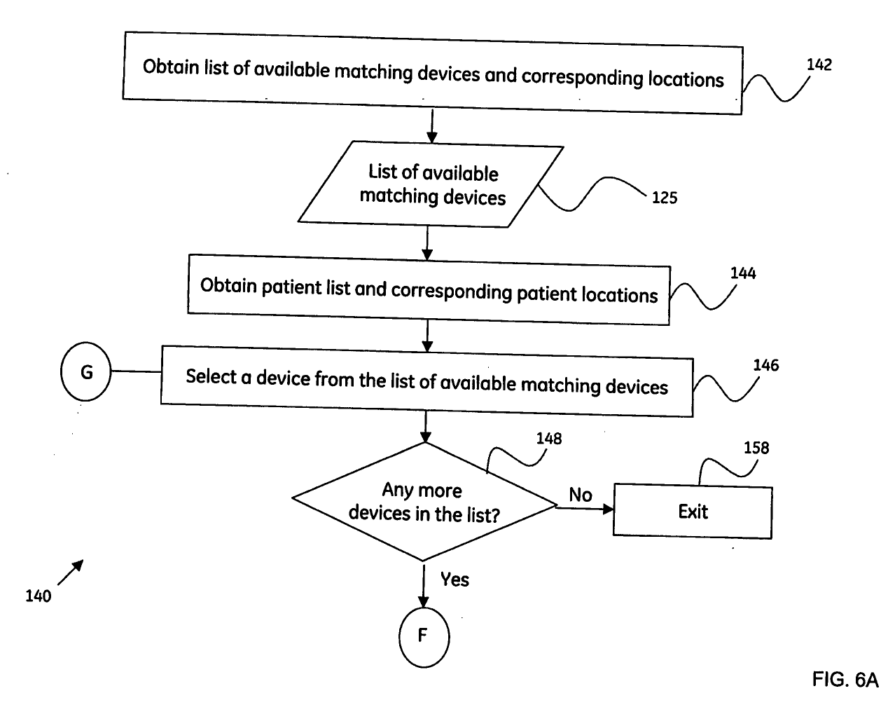

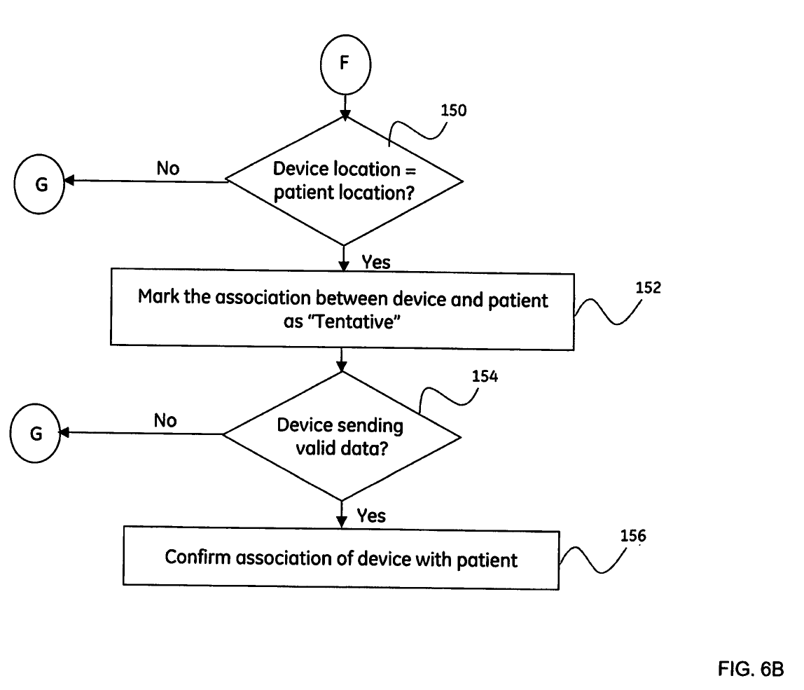

According to aspects of the present technique, a method for automatically associating one or more devices to a patient is presented. More particularly, a method for automatically associating one or more mobile and/or portable devices to the patient is presented. Step 80 may be better understood with reference to FIGS. 6A-6B. Turning now to FIGS. 6A-6B, a flow chart 140 of exemplary logic for automatically associating one or more devices with a patient is presented. The method starts at step 142, where a list of available or unassociated matching devices, such as the unassociated matching devices 125 (see FIG. 5) may be obtained. Additionally, location information associated with each of the devices 125 may also be obtained. As previously noted, the RFID tags coupled to each of the devices 125 may be employed to obtain the corresponding location information. Subsequently, at step 144, a list of patients in the caregiving facility and location information associated with the patients may also be obtained. Here again, RFID tags operatively associated with the patients may be used to obtain location information corresponding to the patients.

In accordance with exemplary aspects of the present technique, the location information associated with the patients and the devices 125 may then be employed to automatically associate one or more devices with a patient. More particularly, the location information associated with a device and the location information associated with a patient may be used to infer an association of the device with the patient. Accordingly, a device from the list of unassociated matching devices 125 may be selected, as indicated by step 146. A check may be carried out at step 148 to verify if all the devices in the list of unassociated matching devices 125 have been associated with one or more patients.

Moreover, at step 148, if it is verified that not all devices have been associated with a patient, then another check may be carried out at step 150 to compare a location of the selected device with a location of a patient to infer an association between the device and the patient. Further, at step 150, if a match between the device location and the patient location is found, then that device may be marked as being associated with that patient, as indicated by step 152. In one embodiment, the association may be marked as a “tentative” association. Marking the association as tentative allows further verification of the association between the device and the patient. Accordingly, a check may be carried out at step 154 to verify if the tentatively associated device is communicating valid patient data. If the tentatively associated device is communicating valid patient data, then the association between that device and the patient may be confirmed, as indicated by step 156.

Returning now to the decision block 154, if it is verified that the tentatively associated device is not communicating valid patient data, then control may be returned to step 146 where another device in the list 125 may be selected. Further, with returning reference to the decision block 150, if the device location and the patient location do not match, then it may be inferred that there is no association between the device and the patient. Also control may be returned to step 146. Additionally, with returning reference to the decision block 148, if it is verified that all the devices in the list 125 have been processed, then the method may be configured to terminate, as depicted by step 158. With returning reference to FIG. 3, at step 82, once the one or more devices are automatically associated with the patient, monitoring of the patient via the associated matching devices may be automatically initiated. Consequent to the monitoring, patient data 84 may be obtained.

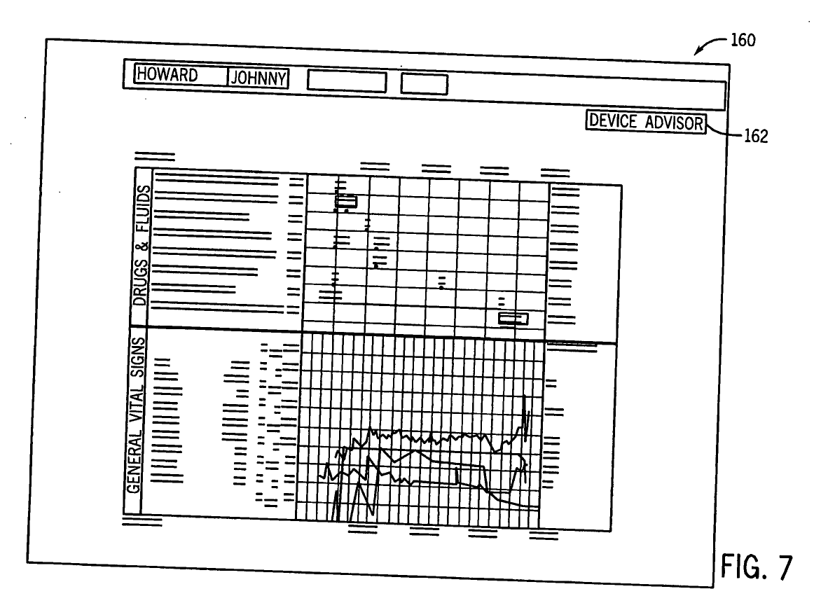

The method of enhanced clinical workflow described hereinabove may be better understood with reference to FIGS. 7-9. FIG. 7 is a front view 160 of a user interface, such as the user interface 36 (see FIG. 1). The user interface 36 may be configured to display patient data, such as patient data 84 (see FIG. 3) obtained via the plurality of associated devices that are operatively coupled to the patient, for example. As described hereinabove, once the patient is admitted, the clinician may trigger the method of enhanced clinical workflow. In one embodiment, the system 10 (see FIG. 1) may be configured to allow the clinician to trigger the method of enhanced clinical workflow. More particularly, in a presently contemplated configuration, the clinician may trigger the method of enhanced clinical workflow by selecting the “Device Advisor” button 162. Accordingly, once the clinician selects the Device Advisor button 162, the system 10 (see FIG. 1) may be configured to direct the clinician initiate the method of enhanced clinical workflow by selecting a predefined template corresponding to the patient.

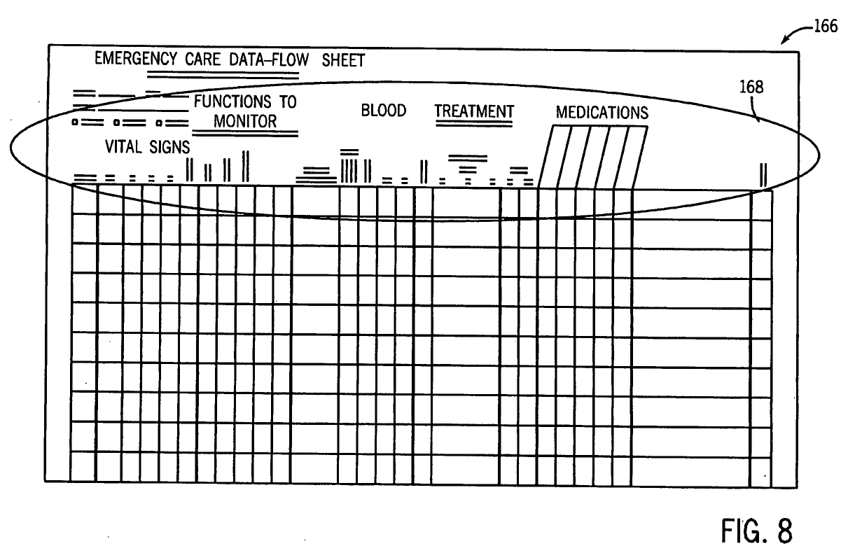

Referring now to FIG. 8, an example of a clinical flow sheet template 166 is illustrated. More particularly, FIG. 8 illustrates an example where the clinical flow sheet template 166 may include a predefined template selected by the clinician at step 68 (see FIG. 3). As depicted in FIG. 8, a list of patient parameters associated with the selected predefined template 166 may generally be represented by reference numeral 168. In other words, the patient parameters 168 may be representative of a set of desired patient parameters that need to be monitored. Further, in the example illustrated in FIG. 8, the list of patient parameters 168 may include a temperature, a blood pressure, a blood oxygen level, a fluid intake and output, or a pulse, for example.

With returning reference to FIG. 7, once the predefined template, such as the predefined template 166 (see FIG. 8) is selected, the system 10 may be configured to automatically deduce of list of parameters, such as the list of patient parameters 168 (see FIG. 8), associated with the selected predefined template 166. Subsequently, in accordance with exemplary aspects of the present technique, it may be desirable to determine a list of matching devices that are configured to monitor the patient parameters 168, track current locations of the available matching devices, the patient, the clinician, or combinations thereof, and provide a plurality of paths to the available matching devices to aid the clinician in gathering the desired matching devices and will be described in greater detail with reference to FIG. 9.

Turning now to FIG. 9, a diagrammatical illustration 170 a portion of the exemplary system 10 of FIG. 1. As depicted in FIG. 9, the processing subsystem 24 (see FIG. 1) is shown as being operatively coupled to the data repository 30 (see FIG. 1), while the patient charting subsystem 32 is also shown as being in operative association with the data repository 30. It may be noted that in one embodiment, the data repository 30 may include an application database. Furthermore, in accordance with aspects of the present technique, the data repository 30 may include a proximity information database 174 configured to store room-to-room proximity information and/or bed-to-bed proximity information. In addition, the data repository 30 may also include a clinical data database 176, a device association database 178, a template information database 180, a device data database 182, and a device information database 184.

Moreover, in accordance with further aspects of the present technique, the patient charting subsystem 32 may include a device determinator module 188, a device tracker module 190 and a device path advisor module 192. The device determinator module 188 may be configured to aid in determining the list of matching devices, while the device tracker module 190 may be configured to aid in tracking current locations of the matching devices. In addition, the device tracker module 190 may also be configured to facilitate checking the availability of the one or more matching devices. The device path advisor module 192 may be configured to provide the clinician a plurality of paths, where the paths are configured to assist the clinician in gathering the available matching devices. The patient charting subsystem 32 may also include a parameter manager module 194, a template manager module 196, a chart viewer module 198, an aggregation and trending manager module 200, and a device manager module 202. In addition, the patient charting subsystem 32 may include a device association manager module 204.

As previously noted, once the patient is admitted, the clinician may select a predefined template. The predefined templates may be stored in the template information database 180, for example. Information associated with the predefined templates may be obtained from the template manager module 196, for example. Subsequently, the system 10 may be configured to automatically obtain a list of desired patient parameters associated with the selected predefined template. In the present example, list of desired patient parameters may be obtained from the parameter manager module 194, for instance.

Further, as previously noted, a list of matching devices configured to monitor the desired patient parameters may be determined. The device determinator module 188 may be employed to determine the list of matching devices. Subsequently, the location of the matching devices may be tracked via use of the device tracker module 190. Additionally, the device tracker module 190 may also be employed to verify availability of the matching devices.

Once the list of available matching devices is determined, a plurality of paths configured to aid the clinician in gathering the desired devices may be determined. The device path advisor module 192 may be configured to determine the plurality of paths. In other words, the device path advisor module 192 may be configured to obtain proximity information associated with the available matching devices from the proximity information database 174, for example, and compute the distance of each device from the patient and/or the clinician based on the proximity information. These paths may then be displayed on the display 34 (see FIG. 1). The clinician may then select an optimal path from the list of paths. Further, once the clinician selects a desirable path, devices associated with the selected path may be locked, thereby preventing any device contention with other searches conducted by other clinicians.

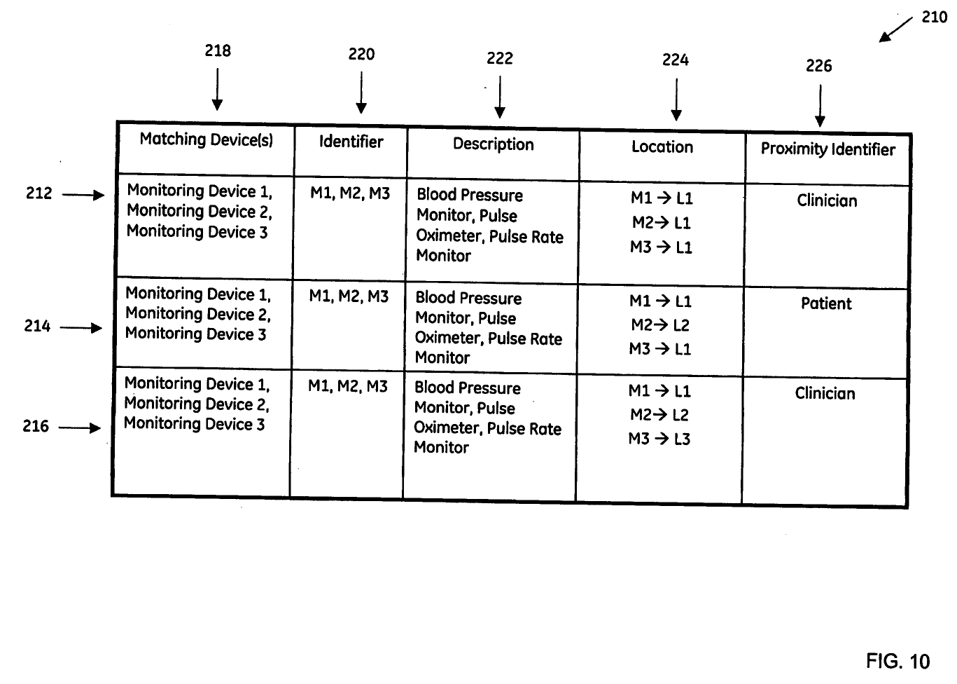

An example 210 of the plurality of paths determined by the system 10 (see FIG. 1) is illustrated in FIG. 10. Also, as previously noted, these paths may be displayed on the display 34 (see FIG. 1), for example. In the illustrated example, the sample set of paths 210 is shown as including three paths. More particularly, the sample set of paths 210 is shown as including a first path Path1 212, a second path Path2 214, and a third path Path3 216. Reference numeral 218 may be representative of a list of matching devices, while an identifier associated with a corresponding matching devices may be indicated by reference numeral 220. In the present example, the list of matching devices 218 may include a first monitoring system having an identifier M1, a second monitoring system having an identifier M2 and a third monitoring system having an identifier M3. Furthermore, a description associated with a corresponding matching device may generally be represented by reference numeral 222. In addition, current locations of the matching devices may be represented by reference numeral 224.

Also, as previously noted, the proximity information may be indicative of a distance between the patient and/or the clinician and each of the available devices. Accordingly, a proximity identifier may be provided, where the proximity identifier may be configured to indicate if the proximity information includes a distance between the patient and the available devices or between the clinician and the available matching devices. The proximity identifier may generally be represented by reference numeral 226. In the present example, proximity identifier “Patient” may be indicative of the distance between the patient and the available matching devices, while “Clinician” may be representative of the distance between the clinician and the available matching devices.

Also, the paths are displayed with an optimal path (path of shortest distance) displayed at the top of the listing of the rules. In the present example of FIG. 10, the first path Path1 212 may be representative of an optimal path as all the three available matching devices M1, M2, M3 are located at the same location, namely location L1. Similarly, referring now to the second path Path2 214, the first monitoring system M1 and the third monitoring system M3 are located at location L1, while the second monitoring system M2 is located at location L2. Furthermore, turning now to the third path Path3 216, first monitoring system M1 is located at location L1, the second monitoring system M2 is located at location L2 and the third monitoring system M3 is at location L3. Alternatively, a graphical representation of the paths may also be displayed on the display 34, for example. Also, as described hereinabove, the paths may be identified as corresponding to the location of the patient or the location of the clinician initiating the device search. In the present example, the first path 212 and the third path 216 may be represented as being relative to the location of the clinician, while the second path 214 may be represented as being relative to the location of the patient.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, including but not limited to C++ or Java or in paradigms like Service Oriented Architecture. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The method of clinical workflow and the system for workflow described hereinabove dramatically simplify procedural workflow by enhancing the speed of procedural time taken to provide care to the patient. Further, the list of patient parameters to be monitored is automatically obtained from the selected predefined template, thereby circumventing need for any manual intervention. Additionally, the list of matching devices is automatically deduced from the selected predefined template using the list of patient parameters to be monitored and hence enhancing the productivity of the clinician in determining the list of desired matching devices. Also, a search for the available matching devices is automatically triggered, thereby circumventing need for any manual intervention. Moreover, the system is configured to alert the clinician to locations of available matching devices by providing the clinician with a plurality of paths to gather the available matching devices, hence enhancing the clinical workflow. Furthermore, the system is configured to allow the clinician to lock the devices associated with the selected path for a predetermined time period, thereby preventing any device contention.

The above-description of the embodiments of the methods of clinical workflow, the system for determining at least one path to one or more device, and the system for clinical workflow have the technical effect of automatically deducing a list of desired matching devices, tracking and gathering the desired matching devices, thereby substantially enhancing the clinical workflow and productivity of the caregivers and patient care.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for clinical workflow, the method comprising:
selecting a predefined template, wherein the predefined template comprises one or more parameters associated with a patient;
determining a list of matching devices, wherein the matching devices are configured to provide the one or more parameters associated with the patient; and
aiding the collection of available matching devices, wherein the available matching devices comprise matching devices from the list of matching devices that are not associated with any patient.

2. The method of claim 1, further comprising:
obtaining location information associated with one or more devices existing within a caregiving facility; and
storing the location information associated with the one or more devices in a first storage.

3. The method of claim 2, wherein obtaining location information comprises obtaining location information via a radio frequency identification device associated with each of the one or more devices.

4. The method of claim 1, wherein determining the list of matching devices comprises:
obtaining the one or more parameters associated with the patient corresponding to the selected predefined template;
determining a list of devices existing within a caregiving facility and parameters provided by the devices;
determining a list of matching devices, wherein the matching devices are configured to monitor the one or more parameters associated with the patient; and
associating the matching devices with at least one of the one or more parameters associated with the patient.

5. The method of claim 4, wherein aiding the collection of the available matching devices comprises:
obtaining the list of matching devices;
determining a list of available matching devices from the list of matching devices, wherein the available matching devices comprise matching devices from the list of matching devices that are not associated with any patient;
computing a distance between the patient and each of the available matching devices, a distance between a clinician and each of the available matching devices, or both; and
determining a plurality of paths between the patient and the clinician and the available matching devices, wherein the plurality of paths is configured to aid in collecting the available matching devices.

6. The method of claim 5, further comprising displaying the plurality of paths on a display.

7. The method of claim 6, further comprising:
selecting an optimal path from the plurality of displayed paths; and
locking the available matching devices associated with the selected path.

8. The method of claim 7, further comprising attaching the collected matching devices to the patient.

9. The method of claim 8, further comprising automatically initiating monitoring of the one or more parameters associated with the patient via the attached devices.

10. The method of claim 4, further comprising automatically associating one or more devices with the patient.

11. The method of claim 10, wherein associating one or more devices with the patient comprises:
obtaining the list of devices existing within the caregiving facility and the location information corresponding to each of the devices existing within the caregiving facility;
obtaining a list of patients and location information corresponding to each patient; and
determining an association between each of the devices and each of the patient by comparing location information corresponding to each device with location information corresponding to each patient.

12. A method for clinical workflow, the method comprising:
selecting a predefined template, wherein the predefined template comprises one or more parameters associated with a patient;
determining a list of matching devices, wherein the matching devices are configured to provide the one or more parameters associated with the patient;
aiding the collection of available matching devices, wherein the available matching devices comprise matching devices from the list of matching devices that are not associated with any patient;
attaching the devices to the patient; and
initiating monitoring of the one or more parameters via the attached devices.

13. The method of claim 12, further comprising associating one or more devices with the patient.

14. A computer readable medium comprising one or more tangible media, wherein the one or more tangible media comprise:
code adapted to select a predefined template, wherein the predefined template comprises one or more parameters associated with a patient;
code adapted to determine a list of matching devices, wherein the matching devices are configured to provide the one or more parameters associated with the patient; and
code adapted to aid the collection of available matching devices, wherein the available matching devices comprise matching devices from the list of matching devices that are not associated with any patient.

15. A location sensing system comprising:
a location sensing platform comprising a location sensor processing module, wherein the location sensor processing module is configured to obtain location information associated with one or more devices, a patient, a clinician, or combinations thereof; wherein each of the one or more devices, the patient, the clinician, or combinations thereof are operatively coupled to a corresponding location tracking device; and
a location proximity detector configured to compute a distance between the patient and the one or more devices, the clinician and the one or more devices, or both.

16. A system for clinical workflow, comprising:
an acquisition subsystem configured to acquire patient data;
a location sensing platform comprising a location sensor processing module, wherein the location sensor processing module is configured to obtain location information associated with one or more devices, a patient, a clinician, or combinations thereof; wherein each of the one or more devices, the patient, the clinician, or combinations thereof are operatively coupled to a corresponding location tracking device;
a location proximity detector configured to compute a distance between the patient and the one or more devices, the clinician and the one or more devices, or both;
a processing subsystem in operative association with the acquisition subsystem and configured to:
select a predefined template, wherein the predefined template comprises one or more parameters associated with a patient;
determine a list of matching devices, wherein the matching devices are configured to provide the one or more parameters associated with the patient; and
aid the collection of available matching devices, wherein the available matching devices comprise matching devices from the list of matching devices that are not associated with any patient.

17. The system of claim 16, wherein the system is further configured to:
obtain location information associated with one or more devices existing within a caregiving facility; and
store the location information associated with the one or more devices in a first storage.

18. The system of claim 16, wherein the system is configured to obtain location information via a radio frequency identification device associated with each of the one or more devices, the one or more patients, the one or more clinicians, or combinations thereof.

19. The system of claim 16, wherein the system is configured to:
obtain the one or more parameters associated with the patient corresponding to the selected predefined template;
determine a list of devices existing within a caregiving facility and parameters provided by the devices;
determine a list of matching devices, wherein the matching devices are configured to monitor the one or more parameters associated with the patient; and
associate the matching devices with at least one of the one or more parameters associated with the patient.

20. The system of claim 19, wherein the system is configured to:
obtain the list of matching devices;
determine a list of available matching devices from the list of matching devices, wherein the available matching devices comprise matching devices from the list of matching devices that are not associated with any patient;
compute a distance between each patient and each of the available matching devices, a distance between each clinician and each of the available matching devices, or both; and
determine a plurality of paths between each patient and each clinician and the available matching devices, wherein the plurality of paths is configured to aid in collecting the available matching devices.

21. The system of claim 20, further configured to display the plurality of paths on a display.

22. The system of claim 21, further configured to:
select an optimal path from the plurality of displayed paths; and
lock the available matching devices associated with the selected path.

23. The system of claim 22, further configured to attach the gathered matching devices to the patient.

24. The system of claim 23, further configured to automatically initiate monitoring of the one or more parameters associated with the patient via the attached devices.

25. The system of claim 19, further configured to automatically associate one or more devices with the patient.
